(19) United States
(12) Patent Application Publication
(10) Pub. No.: US 2008/0147618 A1
(43) Pub. Date: Jun. 19, 2008

(54) Method and Computer Unit for Determining Computer Service Names

(76) Inventor: Volker Bauche, Munchen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/884,986

(22) PCT Filed: Feb. 8, 2006
(86) PCT No.: PCT/EP06/50733

§ 371 Date: Aug. 23, 2007

(30) Foreign Application Priority Data
Feb. 25, 2005 (DE) 10 2005 008 803.1

(51) Int. Cl. G06F 7/06

(52) U.S. Cl. 707/3; 707/E17.014

(57) ABSTRACT

In order to determine a computer service name, a fictitious service name is input, a lexigraphic division of the fictitious service name into sub-strings takes place and a first determination phase is carried out, in which a first group of service names is selected as a result of a string matching of existing service names with sub-strings. Subsequently, a search for synonyms for the lexigraphic portions is made so that additional service names can be determined in an additional determination phase. In addition, a syntax analysis and a further determination phase based on the syntax analysis can take place, to output a narrower selection of determined existing service names. The actual service names that are determined are similar to the fictitious service names that were originally input.

The present invention relates to a method and a computer unit for determining computer service names

The client-server relationship conventionally exists within the field of computer science, i.e. specific computer services (services) are provided by a server and a client is able to call these services.

This pattern is however increasingly being disrupted by equivalent units exchanging their services mutually, peer-to-peer. In such cases each computer unit offers services and makes use of services.

The overall result has been a continuous increase in the total number of services offered in the field. The challenge increasingly consists in recognizing the names of such services, in order to actually be able to use them. Conventional search engines can be of little use in such cases, because these generally operate using a full-text search in which the name of such services must be known precisely, because they can otherwise not be found. The present case consists in determining computer service names on the basis of what is know as fuzzy information. In these cases the precise name of the computer service is unknown, only its determination in respect of the content of its description is known.

Such a method currently does not exist within the prior art. The object of the invention is to provide a method and a computer unit for determining computer service names, which is powerful and finds a plurality of services, even if the predetermined information is not accurate enough for the names of the services to be known or the names are only approximately known.

The object according to the invention is achieved by a method according to claim 1 and a computer unit according to claim 3.

The invention takes advantage of service names having standardized, structured forms. By way of example, the so-called Hungarian notation has service with capital letters without spaces (e.g. getAverage-Temperature). The possibility also exists of providing an underline, e.g. get_average_temperature, etc. The total number of possibilities is not overly high. This standardized form of service names enables fictitious service names to be found. The fictitious service name reflects the fuzzy logic. It could theoretically correspond to the actual name of the service, because it adheres to the above-described conventions. The actual name can however also read completely differently because the service provider has selected a different notation or different terms. This fictitious service name is now divided lexigraphically into sub-strings. In a first determination phase, a string matching is carried out, i.e. service names are found which match the fictitious service names in sub-strings. To increase the yield, a search for synonyms is carried out for the sub-strings. As is generally known, the fictitious service name was only a theoretical possibility for the actual service names. It is highly probable that the real service name will however contain at least synonyms of the sub-strings. These synonyms can be stored in a table or an XML file. A further determination phase is now carried out on the basis of a sub-string matching with these synonyms, thereby increasing the number of actual service names that are determined overall.

A further criterion for finding the correct service is syntax analysis. Depending on the type of service sought, it is necessary to transfer a certain number of parameters. For instance, a service which supplies the temperature values for specific coordinates requires these coordinates as parameters. Actual services which are found, but which do not achieve these parameters, can be excluded as potential search results. The group of services names which is determined overall is herewith reduced, thereby allowing the syntax analysis step either to be carried out before or after the search for synonyms.

A computer unit according to the invention for determining computer service names thus comprises an input unit, a parser (for the lexigraphic division of the fictitious service names, which can be input via the input unit) and a file with synonyms. In a preferred format, this file is an XML file.

Finally, the computer unit according to the preferred form is to comprise a syntax analyzer, in other words a device for analyzing the syntax of the sought and found services, which can inter alia count the parameters of a service call.

The invention is now described in more detail below with reference to the appended drawing, in which;

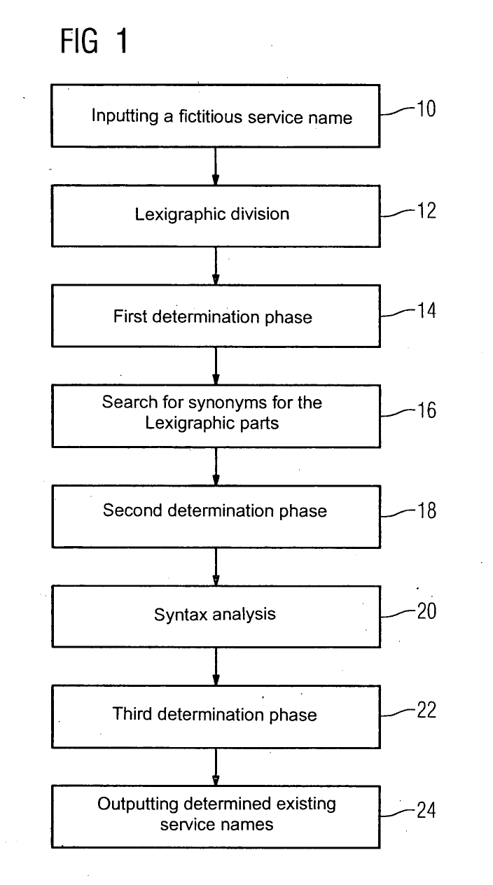

FIG. 1 illustrates a flow diagram of the method according to the invention and

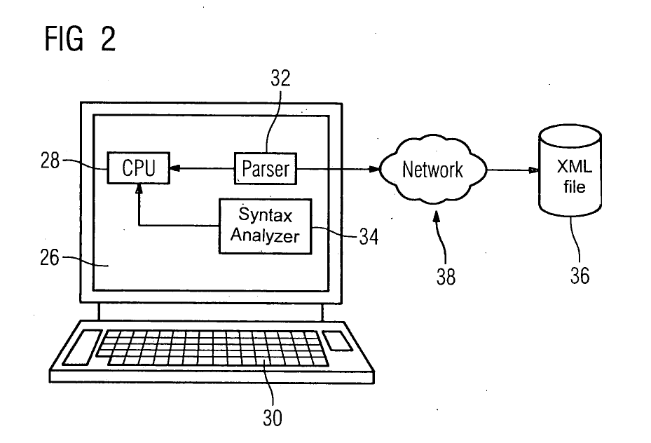

FIG. 2 illustrates a computer unit according to the invention

FIG. 1 indicates that the fictitious service name is first input in step 10. This can be the above-mentioned fictitious name getAverageTemperature (6, 22), which, as indicated in the object, is to be used to find an average temperature between 6 and 22 o'clock.

The lexigraphic division of the fictitious service name, the so-called parsing, is now carried out in step 12. During parsing, the fictitious service name is divided into a number of sub-strings, which represent individual words or meaningful syllables in each instance. A preferred lexigraphic division of our fictitious name is get, Average and Temperature, with the lexigraphic division also potentially resulting in a sub-string temp being sought. In a first determination phase, a scanning of available service names is carried out. These names can be identified in a network, where they are present in a suitable form as names, and where the services can be called up accordingly.

The determination is carried out in the first determination phase 14 on the basis of a so-called sub-string matching. This means that the sub-strings, which are the result of the lexigraphic division 12, are thus compared with parts, in other words sub-strings, of the existing real service names and that specific names are sought as a result of the agreements. With the present example, names were thus sought, which contain the sub-strings “get”, “Average” and “Temperature”. One would for instance obtain get Airpressure(time), get_temp(time), get_mid_temp(time 1, time 2) etc. The final service could be the sought service in the example. Its name nevertheless contains the term “mid” instead of the term “Average”. Such a term can only be determined if a synonym file is accessed, in which synonyms are provided for classical name components of service names. Such a table or file must at present imply that the term “mid” is a synonym for “Average”.

If such a search for synonyms is carried out in a step 16, a second determination phase can subsequently be carried out in step 18, during which a selection from the group of determined service names is carried out or this is extended by finding synonyms. In addition, a syntax analysis 20 can be carried out and in a third determination phase a further restriction can then be carried out. The syntax analysis implies that that command is sought from a group of several determined service names, for instance get_mid_temp (time 1, time 2) and get_mid_temp (time 1, time 3, time 5), said command only being dependent on two variables. The third determination phase 22 can be exchanged with the second determination phase 18 in its sequence, i.e. the steps 20 and 22 can be carried out prior to steps 16 and 18. The second and third determination phase encompass a further determination phase which extends the first determination phase 14. At the end, the group of determined existing service names and/or the only sub group still remaining is output in step 24, so that from now on the user receives service names, which, according to the said criteria, correspond most closely to the fictitious service names input by him.

The method according to the invention can be implemented on a computer unit, this computer unit can be a mobile terminal, with the mobile terminal here being referred to as a computer unit. Such a computer unit 26 is shown in the present case in FIG. 2, which comprises a central processor unit, the CPU 28. Essential here are an input device 30 to input a fictitious service name, a parser 32 for the lexigraphic division of the fictitious service name, a syntax analyzer 34 for analyzing the syntax of the fictitious service name and the found actual service names and an XML file 36 with synonyms for the name components. The elements 32 and 34 can be suitable software components, which can run on the CPU 28 and the XML file 36 must be accessible by the computer unit. FIG. 2 shows a network connection 38, by way of which the XML file 26 can be accessed.

The present invention now enables one or a number of actually existing service names to be determined, as a result of fuzzy input information, said service names standing for a service sought in respect of content.

1.-5. (canceled)

6. A method for determining a computer service name, comprising:
receiving a fictitious service name;
lexigraphic dividing the fictitious service name into a plurality of substrings;
determining a first group of service names based on a string comparison between existing service names and the substrings of the fictitious service name;
searching for synonyms based on the substrings;
determining a second group of service names based on a string comparison between the existing service names and the synonyms; and
outputting the first and second group of service names.

7. The method as claimed in claim 6, further comprising reducing the first or second group of service names prior to the outputting, the reduction based on a syntax analysis.

8. The method as claimed in claim 6, further comprising reducing the first and second group of service names prior to the outputting, the reduction based on a syntax analysis.

9. A computer unit for determining computer service names, comprising:
an input device that receives a fictitious service name;
a parser that lexigraphically divides the fictitious service name into a plurality of substrings; and
a file comprising synonyms for the substrings.

10. The computer unit as claimed in claim 9, wherein the file is an XML file and the computer unit is a mobile unit.

11. The computer unit as claimed in claim 9, wherein the file is retrieved from the Internet.

12. The computer unit as claimed in claim 9,
wherein a first group of service names are determined based on a string comparison between existing service names and the sub-strings of the fictitious service name, and
wherein a second group of service names are determined based on a string comparison between synonyms and the sub-strings of the fictitious service name.

13. The computer unit as claimed in claim 12, further comprises a display device wherein the first and second groups are displayed.

14. The computer unit as claimed in claim 12, further comprising a syntax analyzer that reduces the first group of service names based on a syntax analysis.

15. The computer unit as claimed in claim 12, further comprising a syntax analyzer that reduces the first group of service names based on a syntax analysis.

16. The computer unit as claimed in claim 12, wherein the file is retrieved from the Internet.
